(19) United States
(12) Patent Application Publication
(10) Pub. No.: US 2025/0327892 A1
(43) Pub. Date: Oct. 23, 2025

(54) ASSIGNING A SENSING NODE TO A GROUP BASED ON A CURRENT ACCESS POINT OF SAID NODE

(71) Applicant: SIGNIFY HOLDING B.V., EINDHOVEN (NL)

(72) Inventors: HUGO JOSÉ KRAJNC, EINDHOVEN (NL); PETER DEIXLER, ARLINGTON, MA (US); HENDRIK STEVENS, WAALRE (NL); LEENDERT TEUNIS ROZENDAAL, VALKENSWAARD (NL)

(21) Appl. No.: 18/279,969

(22) PCT Filed: Feb. 28, 2022
(86) PCT No.: PCT/EP2022/054934

§ 371 Date: Sep. 1, 2023

Related U.S. Application Data
(60) Provisional application No. 63/155,874, filed on Mar. 3, 2021.

(30) Foreign Application Priority Data
Apr. 1, 2021 (EP) 21166545.0

(51) Int. Cl. G01S 5/02; H04W 48/20

(52) U.S. Cl. CPC G01S 5/0273; H04W 48/20

(57) ABSTRACT

A system (1) for configuring an RF-based sensing system is arranged to obtain connection information from sensing nodes (31-35, 41-45) of the RF-based sensing system and/or from access points (13, 14) with which the sensing nodes are associated and determine, based on the connection information, a current access point for each of the sensing nodes. The system is further arranged to assign each of the sensing nodes to a group based on the current access point determined for the respective sensing node and configure the RF-based sensing system to use this assignment. Each of the sensing nodes is configured to transmit and/or receive RF signals for the RF-based sensing to and/or from one or more other sensing nodes in the respective sensing node's group.

### FIELD OF THE INVENTION

The invention relates to a system for configuring a radiofrequency-based sensing system, said radiofrequency-based sensing system being able to detect an event and/or state based on changes in received radiofrequency signals, said radiofrequency-based sensing system comprising a plurality of radiofrequency-based sensing nodes, each of said plurality of sensing nodes being associated with one of at least two access points.

The invention further relates to a method of configuring a radiofrequency-based sensing system, said radiofrequency-based sensing system being able to detect an event and/or state based on changes in received radiofrequency signals, said radiofrequency-based sensing system comprising a plurality of radiofrequency-based sensing nodes, each of said plurality of sensing nodes being associated with one of at least two access points.

The invention also relates to a computer program product enabling a computer system to perform such a method.

### BACKGROUND OF THE INVENTION

RF-based sensing is a technology that allows specific events to be determined within an environment based on how the signals sent between at least two devices in that environment are being disturbed. For example, it can be used to detect presence of people, as the human body and its water content significantly absorb wireless signals. Although there are slight differences in the implementation, most wireless signals being used nowadays, such as Zigbee, Bluetooth, Wi-Fi, both at 2.4 GHz and higher frequencies, can be used.

With the popularity of smart home devices and countless streaming media services, whole-house Wi-Fi coverage has become a must. Many of the latest wireless routers can provide strong coverage to most rooms of a typical medium-size house, but larger homes and dwellings with dense walls, multiple floors, metal and concrete substructures, and other structural impediments may require additional components to bring Wi-Fi to areas that the router cannot reach. To solve range problems, a range extender or a second wireless router can be used as second access point, or, since recently, a Wi-Fi mesh network comprising multiple access points, e.g. a router and one or more satellites, may be deployed.

Range extenders do a good job of filling in dead zones, but unless they have a dual radio, they provide only half (or less) the bandwidth of the wireless router. Placing a second wireless router in the home may offer more bandwidth than a range extender but requires a second wired connection. With both the range extender solution and the second wireless router solution, the second access point may be given a new network SSID, e.g. if both access points operate on the same channel. When the user moves from an area of the house to another, a different access point is selected.

With the new Wi-Fi mesh networks, such as Google Wi-Fi, a main router connects directly to another network, e.g. via an ADSL, cable or fiber modem, and a series of one or more satellite modules are placed throughout a user's house. They are all part of a single wireless network, and both the main router and the satellite modules share the same SSID and password.

These multiple network nodes in the house can be used beneficially for RF-based sensing. At least two nodes are needed for doing the sensing, and preferably more (to increase performance, accuracy, and reliability). There may be a manual or automatic selection of nodes which will be involved in RF-based sensing from a larger set of nodes. Such a selection has been disclosed in WO 2020/043592 A1, for example.

The user normally needs to specify the locations of the nodes that are involved in the RF-based sensing. However, the initial complexity of this configuration step can be high enough to keep the user from trying it further or even disabling the RF sensing-based features.

### SUMMARY OF THE INVENTION

It is a first object of the invention to provide a system, which is able to configure an RF-based sensing system with no or limited user input.

It is a second object of the invention to provide a method, which can be used to configure an RF-based sensing system with no or limited user input.

In a first aspect of the invention, a system for configuring a radiofrequency-based sensing system, said radiofrequency-based sensing system being able to detect an event and/or state based on changes in received radiofrequency signals, said radiofrequency-based sensing system comprising a plurality of radiofrequency-based sensing nodes, each of said plurality of sensing nodes being associated with one of at least two access points, comprises at least one input interface, at least one output interface, and at least one processor configured to obtain, via said at least one input interface, connection information from said plurality of sensing nodes and/or from said at least two access points, and determine, based on said connection information, one or more current access points by determining a current access point for each of said plurality of sensing nodes, said at least two access points comprising said one or more current access points.

Said at least one processor is further configured to assign each of said plurality of sensing nodes to a group based on said current access point determined for said respective sensing node, and configure, via said at least one output interface, said radiofrequency-based sensing system to use said assignment, each of said plurality of sensing nodes being configured to transmit and/or receive radiofrequency signals for said radiofrequency-based sensing to and/or from one or more other sensing nodes in said respective sensing node's group.

By grouping sensing nodes of an RF-based sensing system based on their current access points, a user is able to skip the initial configuration step of specifying locations of the nodes. This grouping may not be fine grained but should be detailed enough so that it can provide good results to the user. Said at least two access points may comprise a mesh router and one or more mesh satellites, for example. Said at least two access points may alternatively or additionally comprise a range extender. Typically, at least one of said two access points comprises a router to a data communication network. Said access points may be Wi-Fi access points, but may alternatively use other RF technologies, e.g. Zigbee.

Said radiofrequency-based sensing system may, for example, be able to detect presence of humans, animals and/or objects based on the changes in received radiofrequency signals. For instance, a change in subsequently received RF signals may indicate the arrival of a person or a change between a received RF signal and a reference RF signal when the room was empty may indicate the presence of a person in the room. Not just presence but also, for example, activity (e.g. typing), vital signs, gestures may be detected.

A sensing node that is associated with an access point may be included in a data communication network. This data communication network may comprise only devices that are connected to the access point or may comprise further (wired and/or wireless) devices, e.g. when the data communication network is a home network or a company network. However, it is not necessary that a sensing node that is associated with an access point is included in a data communication network; a sensing node may connect to the access point merely for the sensing function and not be truly part of the data communication network.

Said at least one processor may be configured to assign a first sensing node, a second sensing node, a third sensing node, and a fourth sensing node of said plurality of sensing nodes to a first group, assign said first sensing node and said second sensing node to a first subgroup of said first group, assign said third sensing node and said fourth sensing node to a second subgroup of said first group, and configure said radiofrequency-based sensing system to use said assignment of said first, second, third, and fourth sensing nodes to said first and second subgroups of said first group, each of said first, second, third, and fourth sensing nodes transmitting and/or receiving radiofrequency signals for said radiofrequency-based sensing to and/or from one or more other sensing nodes in said respective sensing node's subgroup. Other sensing nodes may be grouped in a similar manner. More than two subgroups may be used. Subgroups may be formed for multiple groups.

Assigning nodes not just to a group but also to subgroups of this group may be beneficial if the group comprises at least four nodes, and each subgroup comprises at least two nodes. This may be used to achieve more fine-grained RF-based sensing or more accurate RF-based sensing on a group level if the results of the subgroups are combined. The subgroups may be disjunct or have overlap. As an example of the latter, one of the four sensing nodes may be assigned to both subgroups.

Said at least one processor may be configured to determine a link quality between said first, second and third sensing nodes, assign said first sensing node and said second sensing node to said first subgroup based on said link qualities, and assign said second sensing node and said third sensing node to said second subgroup based on said link qualities. By assigning nodes with at least a good link quality between them to the same subgroup, RF-based sensing in the subgroup may be improved.

Preferably, these link qualities specifically reflect the quality of the link for RF-based sensing, i.e. reflect whether the wireless link is affected by presence/activity in the targeted sensing area. For this, a sufficient amount of the wireless signal must interact with the human body mass. For instance, if highly directional 60 GHz Wi-Fi-based sensing is used, a directional radio shot may be performed from the first sensing node to the second sensing node. Certain measures of link quality between the two sensing nodes might then indicate that the link excellent, but the radio shot may only graze the human body and hence cause only little deviation in the time-series data of the Wi-Fi signal quality.

Said at least one processor may be configured to determine a link quality between a sensing node of said plurality of sensing nodes and said at least two access points, determine a suitability of frequency resources used by said at least two access points for radiofrequency-based sensing, select one of said at least two access points based on said link qualities and said suitability, and cause said sensing node to use said selected access point as current access point. For example, if a node is able to receive transmissions from two access points with a similar signal strength, the node may be directed to connect to the access point with a slightly lower received signal strength if it uses a band or channel that gives cleaner RF-based sensing results. The sensing node may use the selected access point to connect to a data communication network or just for RF-based sensing, for example.

If multiple sensing nodes are connected to the same access point and another access point is considered to be preferable for one of these sensing nodes, then the multiple sensing nodes are preferably all directed to connect to the other access point. For example, if two standing lamps to the right and left of a bed are used for breathing detection, they should be moved to the other access point together. However, a third ceiling-based light in the same room, which does not play a role in the breathing detection, can be easily moved to another access point.

For beam steering Wi-Fi, the frequency resources may differ per spatial direction. Hence, if a Wi-Fi AP is used to stream HD video to a laptop on the right side of a room, there is only little extra bandwidth for the AP to perform RF-based sensing with the table lamp next to the laptop. However, the AP has still ample bandwidth to the luminaire on the left side of the room, as this wireless channel uses a different directional antenna.

Said at least one processor may be configured to cause said sensing node to use said selected access point as current access point in a first mode, said sensing node using a further access point as current access point in said second mode, said sensing node being used to perform said radiofrequency-based sensing in said first mode, said sensing node not being used to perform said radiofrequency-based sensing in a second mode. For example, in the first mode, the sensing node may be directed to connect to an access point that has been selected based on a suitability for RF-based sensing, and in the second mode, the sensing node may choose a further access point in the normal way, e.g. only based on received signal strengths. The sensing node may be instructed when to switch to the first mode and when to switch to the second mode.

Said link qualities may be determined based on received signal quality parameters, e.g. received signal strengths, and/or propagation delays of transmissions between pairs of devices and/or based on channel state information associated with said transmissions, for example. Alternatively or additionally, said link qualities may be determined based on roundtrip times of roundtrip message exchanges between pairs of devices. Alternatively or additionally, for each of said link qualities, a respective link quality between one device and another device may be determined based on a loss of packets transmitted by said one device to said other device.

Said transmissions between said pairs of devices may be performed multiple times, e.g. with different transmission powers. This may be done in order to determine a more accurate link quality. Performing the multiple transmission with different transmission powers may make it possible to make a clearer differentiation between groups or subgroups: only links between sufficiently close-by nodes could be considered good or excellent and others not.

One or more of the at least two access points may, like the (regular) sensing nodes, also be able to transmit and/or receive radiofrequency signals for the radiofrequency-based sensing. For instance, the RF-based sensing system may perform RF-based sensing on a first communication link between a first light and a first Wi-Fi access point and at the same time perform RF-based sensing between the first light and a second light. Hence, the first light participates in two different RF sensing links. The first light may be assigned to the task of transmitting the RF signals and the second light and the first Wi-Fi access point may be assigned the task of receiving these RF signals, thereby resulting in the use of the same transmissions for both sensing links.

As an access point normally has more processing power than a light, the first Wi-Fi access point may receive the RF signals from the first light, collect RF sensing data from the second light, determine the signal quality parameters from the received RF sensing signals and the collected RF sensing data, and then run a sophisticated RF-based sensing algorithm on the signal quality parameters. Alternatively, the first Wi-Fi access point might not collect RF sensing data from the second light and determine the signal quality parameters only from the received RF sensing signals. In this case, the algorithm processing of the sensing link between the first light and the second light could be run locally on either the first light or second light.

Said at least one processor may be configured to determine a link quality between a sensing node of said plurality of sensing nodes and said at least two access points, a distance between said sensing node and a target sensing area being smaller than a threshold, determine one or more distances between one or more of said at least two access points and said target sensing area, said one or more access points being able to transmit and/or receive radiofrequency signals for said radiofrequency-based sensing in said target sensing area, select one of said at least two access points based on said link qualities and said one or more distances, and cause said sensing node to use said selected access point as current access point.

It is advantageous to use one or more RF transmitters and one or more RF receivers physically close to a target sensing area (e.g. a human body). If a first access point is physically close to the target sensing area and able to transmit and/or receive radiofrequency signals for the radiofrequency-based sensing, it may be beneficial to cause (regular) sensing nodes which are also physically close to the target sensing area to use the first access point instead of a second access point, if possible, even when these sensing nodes are physically closer to the second access point than to the first access point.

Said at least one processor may be configured to determine a link quality between a sensing node of said plurality of sensing nodes and said at least two access points, determine whether one or more wireless multipaths from said sensing node to said at least two access points pass through a target sensing area and have a signal strength exceeding a minimum signal strength, select one of said at least two access points based on said link qualities and based on said determination whether one or more wireless multipaths pass through said target sensing area, and cause said sensing node to use said selected access point as current access point.

This is beneficial, because not only distance plays a role whether an access point is well positioned to perform RF sensing on the target sensing area. For example, an access point may be selected if a sufficient number of wireless multipaths between the sensing node and the access point pass through the target sensing area and each of the multipaths is sufficiently strong. The wireless multipaths are affected by building materials, shape of the room, and objects between the access point and the sensing node, amongst others. For instance, while the access point may be physically close to the target sensing area, a metal bookshelf room divider may block some of the multipaths from reaching the target sensing area.

A room may comprise several sub-areas/volumes. A first area may be the volume between the floor and 1.8 m height (representing the volume which potentially can be occupied by a human body). A second area may the upper air space between the 1.8 m height and the ceiling (this area may be occupied by HVAC devices such as a ceiling fan). The periodic movement of a ceiling fan will influence the signal quality parameters of wireless multipaths passing through.

The system may analyze the timeseries of signal quality parameters to distinguish whether a certain multipath sees a periodic variation in the signal quality parameters due to the ceiling fan. Those paths are considered not to pass through the target sensing area. On the other hand, if occasionally persons are present in a certain area, this will cause variations in the multipath passing through that certain area due to breathing/movement typical for humans. If the system can pick up those kinds of variations on a certain multipath, it can conclude that this multipath has just passed through an area which is occupied by a human. From that moment forwards, the system may define this specific multipath as one passing through the target sensing area.

Said at least one processor may be configured to select said access point based on both said one or more afore-mentioned distances and said determination whether one or more wireless multipaths pass through said target sensing area.

In a second aspect of the invention, a method of configuring a radiofrequency-based sensing system, said radiofrequency-based sensing system being able to detect an event and/or state based on changes in received radiofrequency signals, said radiofrequency-based sensing system comprising a plurality of radiofrequency-based sensing nodes, each of said plurality of sensing nodes being associated with one of at least two access points, comprises obtaining connection information from said plurality of sensing nodes and/or from said at least two access points, and determining, based on said connection information, one or more current access points by determining a current access point for each of said plurality of sensing nodes, said at least two access points comprising said one or more current access points.

Said method further comprises assigning each of said plurality of sensing nodes to a group based on said current access point determined for said respective sensing node, and configuring said radiofrequency-based sensing system to use said assignment, each of said plurality of sensing nodes being configured to transmit and/or receive radiofrequency signals for said radiofrequency-based sensing to and/or from one or more other sensing nodes in said respective sensing node's group. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for configuring a radiofrequency-based sensing system, said radiofrequency-based sensing system being able to detect an event and/or state based on changes in received radiofrequency signals, said radiofrequency-based sensing system comprising a plurality of radiofrequency-based sensing nodes, each of said plurality of sensing nodes being associated with one of at least two access points.

The executable operations comprise obtaining connection information from said plurality of sensing nodes and/or from said at least two access points, determining, based on said connection information, one or more current access points by determining a current access point for each of said plurality of sensing nodes, said at least two access points comprising said one or more current access points, assigning each of said plurality of sensing nodes to a group based on said current access point determined for said respective sensing node, and configuring said radiofrequency-based sensing system to use said assignment, each of said plurality of sensing nodes being configured to transmit and/or receive radiofrequency signals for said radiofrequency-based sensing to and/or from one or more other sensing nodes in said respective sensing node's group.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system in a first type of network;

FIG. 2 is a block diagram of the filet embodiment of the system in a second type of network;

FIG. 3 is a block diagram of a second embodiment of the system in the first type of network;

FIG. 4 is a flow diagram of a first embodiment of the method;

FIG. 5 is a flow diagram of a second embodiment of the method;

FIG. 6 shows an example of two groups of RF sensing nodes;

FIG. 7 shows an example of four subgroups of RF sensing nodes;

FIG. 8 is a flow diagram of a third embodiment of the method;

FIG. 9 illustrates multiple ways of determining link quality;

FIG. 10 shows an example of different access points being used by sensing nodes in different modes; and

FIG. 11 is a block diagram of an exemplary data processing system for performing the method of the invention.

Corresponding elements in the drawings are denoted by the same reference numeral.

### DETAILED DESCRIPTION OF THE EMBODIMENTS

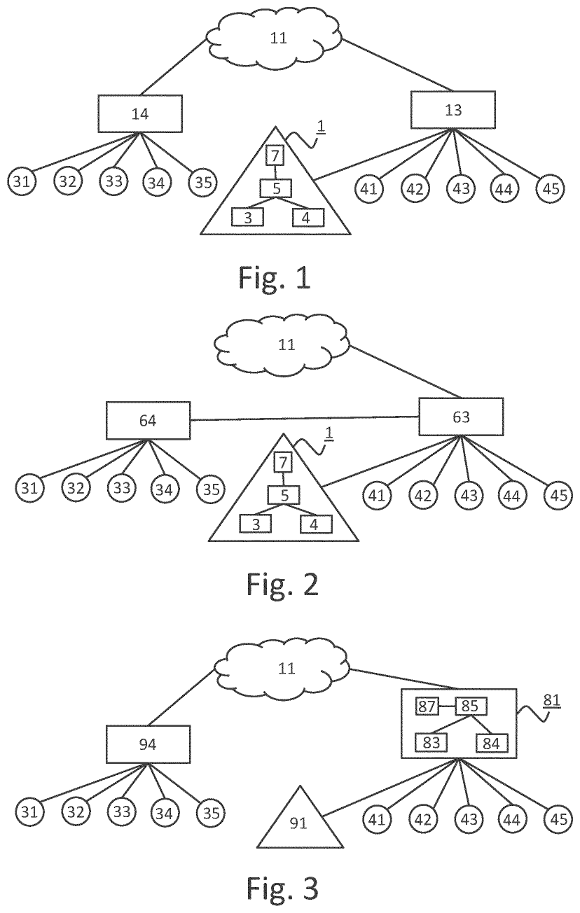

FIG. 1 shows a first embodiment of the system for configuring a radiofrequency-based sensing system. The radiofrequency-based sensing system is able to detect an event and/or state based on changes in received radiofrequency signals. The radiofrequency-based sensing system comprises a plurality of radiofrequency-based sensing nodes 31-35 and 41-45. The sensing nodes are associated with one of at least two access points, e.g. in order to connect to a data communication network. The sensing/network nodes 31-35, 41-45 may be lighting devices, for example.

In this first embodiment, the system is a controller 1. The controller 1 communicates with nodes 31-35 and 41-45, e.g. using Wi-Fi or Zigbee technology. In the example of FIG. 1, the controller 1 is part of the radiofrequency-based sensing system. In the example of FIG. 1, two access points 13 and 14 are independently connected to a local or wide area network 11. In the example of FIG. 1, the controller 1 is connected to the access point 13, e.g. via Ethernet or Wi-Fi, and may be able to communicate with one or more of the nodes 31-35, 41-45 via the access point 13. The controller 1 may also be able to communicate directly with one or more of the nodes 31-35, 41-45, e.g. via Bluetooth or Zigbee.

The controller 1 comprises a receiver 3, a transmitter 4, a processor 5 and memory 7. The processor 5 is configured to obtain, via the receiver 3, connection information from the plurality of sensing nodes 31-35, 41-45 and/or from the access points 13-14, and determine, based on the connection information, one or more current access points by determining a current access point (access point 13 or 14) for each of the nodes 31-35, 41-45. The processor 5 is further configured to assign each of the plurality of sensing nodes 31-35, 41-45 to a group based on the current access point determined for the respective sensing node, and configure, via the transmitter 4, the radiofrequency-based sensing system to use the assignment. Each of the plurality of sensing nodes 31-35, 41-45 is configured to transmit and/or receive radiofrequency signals for the radiofrequency-based sensing to and/or from one or more other sensing nodes in the respective sensing node's group. In the embodiment of FIG. 1, the controller 1 transmits configuration messages directly to the sensing nodes 31-35, 41-45.

In the example of FIG. 1, the controller 1 determines the characteristics of received radio frequency signals from data received from the nodes 31-35, 41-45. The nodes 31-35, 41-45 each comprise a radio frequency sensor. The radio frequency signals are received by these radio frequency sensors. Signal strength data (RSSI, Received Signal Strength Indication) or Wi-Fi CSI of the node-to-node connections is collected.

A node determines at least one characteristic from the radio frequency signal(s) received by its radio frequency sensor, after which the node includes the at least one characteristic in data transmitted to the controller 1. The characteristics may comprise power levels/signal strengths (e.g. RSSI) and/or Channel State Information (CSI), for example. Changes in received signal strength or Wi-Fi CSI can be measured at each of the nodes when wireless packets are sent around in the network.

The controller 1 may process the RSSI or CSI data from each node per group or subgroup to look for specific changes and transitions on the collected signal strength data. By collecting signal strength variations in different (sub) groups, a detection algorithm can conclude that there was a change in the environment, based on information from each of the (sub) groups.

In a first example, a user has a two-floor home and in order to have enough Wi-Fi coverage throughout has bought a range extender for the top floor, as the wireless router is in the ground floor and does not reach properly (all locations on) the top floor. The user has equipped most rooms with Wi-Fi lights, which support RF-based sensing among themselves (or can get a software update to enable this feature). The user decides to try out this feature and enables it via an app.

In order to provide immediate feedback and a live experience to the user, the controller 1 decides to group lights based on which access point they connect to: Lights on the ground floor are connected to the wireless router, with SSID: WiFiGroundFloor Lights on the top floor are connected to the range extender, with SSID: WiFiTopFloor

For a simple grouping, the system determines that only two RF sensing groups will be created: one including just the lights on the ground floor, and the other including just the lights on the top floor. This can be done very easily by simply determining to which SSID is each light connected. It also assures that there is a good connection between lights within each set since there is no split over the two floors within a group. In this way, the user can quickly see that the technology does work, and what benefits it provides, because he gets detected in either floor and can later on decide to finetune the settings further.

In the embodiment of the controller 1 shown in FIG. 1, the controller 1 comprises one processor 5. In an alternative embodiment, the controller 1 comprises multiple processors. The processor 5 of the controller 1 may be a general-purpose processor, e.g. ARM-based, or an application-specific processor. The processor 5 of the controller 1 may run a Unix-based operating system for example. The memory 7 may comprise one or more memory units. The memory 7 may comprise one or more hard disks and/or solid-state memory, for example.

The receiver 3 and the transmitter 4 may use one or more wired and/or wireless communication technologies, e.g. Ethernet, Wi-Fi, Zigbee and/or Bluetooth, to communicate with the access point 13 and/or the nodes 31-35, 41-49, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The controller 1 may comprise other components typical for a controller such as a power connector.

The invention may be implemented using a computer program running on one or more processors. In the embodiment of FIG. 1, the system comprises a single device. In an alternative embodiment, the system comprises multiple devices.

In the example of FIG. 1, the two access points 13 and 14 are independently connected to the local or wide area network 11. FIG. 2 shows an alternative topology in which a wireless LAN comprises a mesh router 63 and a mesh satellite 64 as access points. The mesh satellite 64 uses a backhaul to the mesh roller 53 to receive data from and transmit data to the local or wide area network 11. The data originates from or is intended for nodes 31-35. The controller 1 may obtain information from the mesh router 13 specifying which node is connected to mesh router 13 and which node is connected to mesh satellite 64.

FIG. 3 shows a second embodiment of the system for configuring a radiofrequency-based sensing system. In this second embodiment, the system is an access point 81. In the example of FIG. 3, sensing nodes 41-45 are connected to the access point 81, e.g. using Wi-Fi, and access point 81 and further access point 94 are independently connected to the local or wide area network 11. In the example of FIG. 3, a controller 91 is also connected to the access point 81, e.g. via Ethernet or Wi-Fi.

The access point 81 comprises a receiver 83, a transmitter 84, a processor 85 and memory 87. The processor 85 is configured to obtain, via the receiver 83, connection information from the plurality of sensing nodes 41-45 and determine, based on the connection information, that access point 81 is the current access point for sensing nodes 41-45. When a sensing node connects to the access point 81, this sensing node is added to the connection information. When a sensing node is disconnected from the access point 81, this sensing node is removed from the connection information.

The processor 85 is further configured to assign each of the sensing nodes 41-45 to the same group based, as the sensing nodes 41-45 are all connected to the same access point 81. The processor 85 is further configured to configure, via the transmitter 84, the radiofrequency-based sensing system to use the assignment. Each of the plurality of sensing nodes 41-45 is configured to transmit and/or receive radiofrequency signals for the radiofrequency-based sensing to and/or from one or more other sensing nodes in the respective sensing node's group.

In the embodiment of FIG. 3, the access point 81 transmits a configuration message to the controller 91. This configuration message identifies the sensing nodes 41-45 The access point 95 may be configured in a similar manner as access point 81, determine a group comprising sensing nodes 31-35, and transmit a configuration message to the controller 91, either directly, e.g. using Zigbee or Bluetooth, or indirectly, e.g. via access point 81.

In the embodiment of the access point 81 shown in FIG. 1, the access point 81 comprises one processor 5. In an alternative embodiment, the access point 81 comprises multiple processors. The processor 5 of the access point 81 may be a general-purpose processor, e.g. ARM-based, or an application-specific processor. The processor 5 of the access point 81 may run a Unix-based operating System for example. The memory 7 may comprise one or more memory units. The memory 7 may comprise one or more hard disks and/or solid-state memory, for example.

The receiver 83 and the transmitter 84 may use one or more wired and/or wireless communication technologies, e.g. Wi-Fi and/or Zigbee, to communicate with the nodes 41-45 and the controller 81, for example. In an alternative embodiment, multiple receivers and/or multiple transmitters are used instead of a single receiver and a single transmitter. In the embodiment shown in FIG. 3, a separate receiver and a separate transmitter are used. In an alternative embodiment, the receiver 83 and the transmitter 84 are combined into a transceiver. The access point 81 may comprise other components typical for an access point such as a power connector.

The invention may be implemented using a computer program running on one or more processors. In the embodiment of FIG. 3, the system comprises a single device. In an alternative embodiment, the system comprises multiple devices.

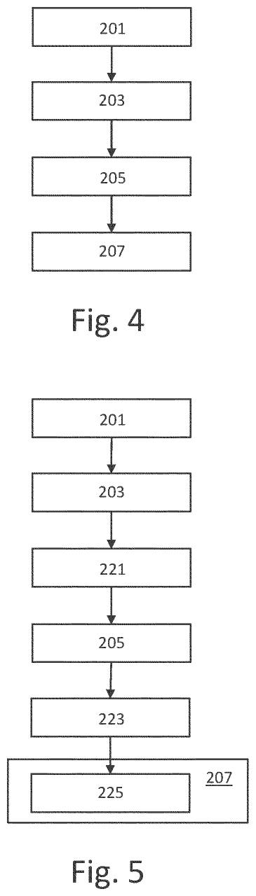

A first embodiment of the method of configuring a radiofrequency-based sensing system is shown in FIG. 4. The radiofrequency-based sensing system is able to detect an event and/or state based on changes in received radiofrequency signals. The radiofrequency-based sensing system comprises a plurality of radiofrequency-based sensing nodes. The sensing nodes are associated with one of at least two access points.

A step 201 comprises obtaining connection information from the plurality of sensing nodes and/or from the at least two access points. A step 203 comprises determining, based on the connection information, one or more current access points by determining a current access point for each of the plurality of sensing nodes. The at least two access points comprise the one or more current access points.

In Wi-Fi networks, it may be possible to determine to exactly which access point a node is connected based on the SSID provided by the access point to which the node is connected. This information may be obtained from the nodes, for example. If it is not possible to discern via SSID to which access point a node is connected, e.g. in a mesh network, it may be possible to determine to exactly which access point a node is connected based on information received from the mesh router.

A step 205 comprises assigning each of the plurality of sensing nodes to a group based on the current access point determined for the respective sensing node. A step 207 comprises configuring the radiofrequency-based sensing system to use the assignment. Each of the plurality of sensing nodes is configured to transmit and/or receive radiofrequency signals for the radiofrequency-based sensing to and/or from one or more other sensing nodes in the respective sensing node's group.

A second embodiment of the method of configuring a radiofrequency-based sensing system is shown in FIG. 5. This second embodiment is an extension of the first embodiment of FIG. 4. In the embodiment of FIG. 5, a step 221 is performed between steps 203 and 205, a step 223 is performed between steps 205 and 207, and step 207 is implemented by a step 225.

Step 221 comprises determining a link quality between different sensing nodes, including at least a first sensing node, a second sensing node, a third sensing node, and a fourth sensing node. The first sensing node, the second sensing node, the third sensing node, and the fourth sensing node, are connected to the same current access point.

Step 205 comprises assigning each of the plurality of sensing nodes to a group based on the current access point determined for the respective sensing node. In step 205, the first sensing node, the second sensing node, the third sensing node, and the fourth sensing node are assigned to the first group.

Step 223 comprises assigning the sensing nodes of at least one of the groups to subgroups. In particular, step 223 comprising assigning the first sensing node and the second sensing node to a first subgroup of the first group and assigning the third sensing node and the fourth sensing node to a second subgroup of the first group.

In the embodiment of FIG. 5, the sensing nodes of the first group are assigned to the subgroups based on the link qualities. The link qualities may be determined based on received signal quality parameters, e.g. received signal strengths, and/or propagation delays of transmissions between pairs of devices and/or based on channel state information associated with the transmissions, for example.

Step 225 comprises configuring the radiofrequency-based sensing system to use the assignment. In particular, step 225 comprises configuring the radiofrequency-based sensing system to use the assignment of the first, second, third and fourth sensing nodes to the first and second subgroups of the first group. Each of the first, second, third, and fourth sensing nodes transmit and/or receive radiofrequency signals for the radiofrequency-based sensing to and/or from one or more other sensing nodes in the respective sensing node's subgroup.

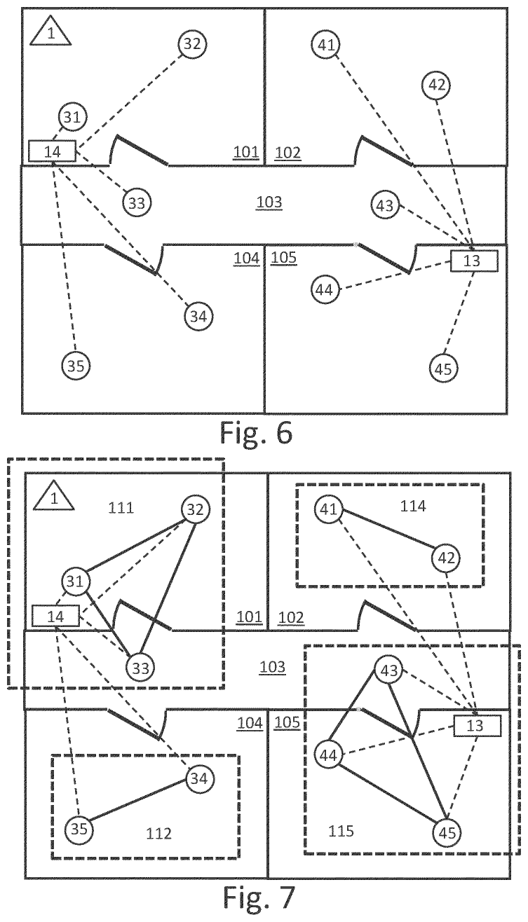

FIG. 6 shows an example of an office floor with the RF sensing/network nodes of FIG. 1. The office floor comprises four offices 101, 102, 104, and 105 and a hallway 103. The nodes 31 and 32 are located in office 101. The nodes 41 and 42 are located in office 102. The nodes 34 and 35 are located in office 104. The nodes 44 and 45 are located in office 105. The nodes 33 and 43 are located in hallway 103. Nodes 31-35 and 41-45 may be lighting devices, e.g. all lighting devices installed in spaces 101-105 or a subset of all lighting devices installed in spaces 101-105.

In the example of FIG. 6, nodes 31-35 are connected to access point 14 and nodes 41-45 are connected to access point 13. As a result of performing the method of FIG. 4, nodes 31-35 are assigned to the same RF sensing group, e.g. group A, and nodes 41-45 are assigned to the same RF sensing group, e.g. group B. Nodes 31-35 are assigned to a different sensing group than nodes 41-45. The controller 1 analyzes the data collected by the nodes 31-35 and 41-45. The controller 1 may also collect data itself.

In the example of FIG. 7, as a result of performing the method of FIG. 4, the sensing nodes 31-35 and 41-45 are assigned to subgroups. Sensing nodes 31, 32, and 33, which are connected to access point 14, are assigned to subgroup 111. Sensing nodes 34 and 35, which are also connected to access point 14, are assigned to subgroup 112. Sensing nodes 41 and 42, which are connected to access point 13, are assigned to subgroup 114. Sensing nodes 43, 44, and 45, which are also connected to access point 13, are assigned to subgroup 115. These subgroups are used for RF sensing, but do not affect the transmission and receipt of data to and from the computer network.

In the example of FIG. 7, the nodes of both groups are assigned to subgroups. Alternatively, the nodes of only one of the groups may be assigned to subgroups. In the example of FIG. 7, the nodes are assigned to two subgroups. Alternatively, nodes may be assigned to more than two subgroups.

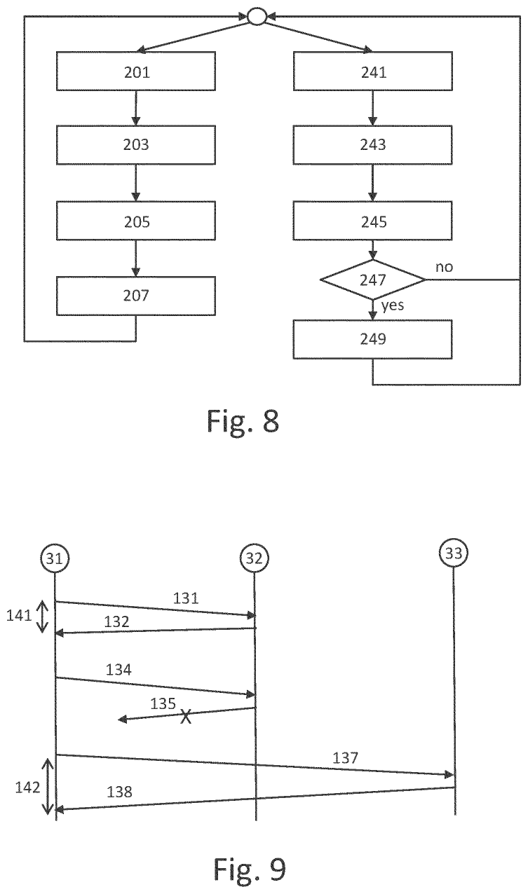

A third embodiment of the method of configuring a radiofrequency-based sensing system is shown in FIG. 8. This third embodiment is an extension of the first embodiment of FIG. 4. In the embodiment of FIG. 8, steps 241, 243, 245, 247, and 249 are performed at least partly in parallel with at least part of steps 201-207. In an alternative embodiment, steps 241-249 are performed after steps 201-207, for example.

Step 241 comprises determining, for each of the sensing nodes, a link quality between a sensing node of the plurality of sensing nodes and the at least two access points. The link qualities may be determined based on received signal quality parameters, e.g. received signal strengths, and/or propagation delays of transmissions between pairs of devices and/or based on channel state information associated with the transmissions, for example.

Step 243 comprises determining a suitability of frequency resources used by the at least two access points for radiofrequency-based sensing. As a first example, if multiple frequency bands (e.g. at least two of 2.4 GHZ, 5 GHZ, and 60 GHz) are used by one or more of the access points, this is may be taken into account in step 243 and may therefore influence the grouping. Certain channels within a frequency band may also be preferred over other channels within this frequency band.

As a second example, mesh routers typically have radios for communicating on two or even three frequency bands at the same time. Both the main router and first satellite module may dedicate certain bands to intra-node-only data, switching channels to reduce congestion, or mixing client data and “backhaul” data on the same channel. For instance, eero WiFi routers three radios; a first radio for 2.4 GHz and a second and third radio for 5 GHz. Eero dedicates the second radio to the 5 GHz low band (channels 36-48) and the third radio to the high band (channels 149-165).

While Wi-Fi devices can connect to any of its three radios, the WiFi mesh router system may decide at times to allocate a band (e.g. 5 GHz high band) to backhaul between the WiFi mesh routers only (i.e. no WiFi devices are allowed in this band at this time). With RF-based sensing, a first band or first channel may be preferred over a second band or second channel, as it gives cleaner RF sensing results (e.g. due to presence of a non-WiFi device such as a microwave oven or baby monitor polluting a certain part of the spectrum).

Step 245 comprises selecting, for each of the sensing nodes, one of the at least two access points based on the link qualities and the suitability. Step 247 comprises determining whether the access point selected for any of the sensing nodes is different than the current access point of that sensing node. If so, step 249 is performed. If not, step 201 and/or step 241 are repeated and the method proceeds as shown in FIG. 8. Step 249 comprises causing the sensing node(s) for which a different access point was selected in step 245 to use the selected access point as current access point

Step 249 may comprise transmitting one or more messages to the relevant sensing node(s). For example, WiFi end devices will normally decide which band they will use to connect. However, Band Steering features offered for instance by Google WiFi will guide the connected devices to the band with the best performance. This steering of devices is done dynamically.

After step 249, step 201 and/or step 241 are repeated and the method proceeds as shown in FIG. 8. For instance, if a WiFi mesh router changes the channels which are available for lights, which are nodes of the RF-Based sensing system, or if the WiFi mesh router differently allocates non-lighting WiFi end devices, it may be advantageous to switch a first light from first being connected to the WiFi mesh router to, after allocation changes are made by the WiFi mesh system, being connected to the WiFi mesh satellite.

Link qualities may be determined based on received signal quality parameters, e.g. received signal strengths, and/or propagation delays of transmissions between pairs of devices and/or based on channel state information associated with the transmissions, for example. For instance, nodes may share the received RSSI values with the system performing the method of FIG. 5. The received RSSI values may be grouped into categories as for example shown in Table 1.

TABLE 1

| Signal strength | Link quality |
|---|---|
| ++ | Excellent |
| + | Good |
| 0 | Weak |
| − | No signal |

The system may then build an RSSI heatmap and decide based on this heatmap which subgroups to make. In the example of FIG. 7, the heatmap shown in Table 2 may be made.

TABLE 2

| | 31 | 32 | 33 | 34 | 35 | Result |
|---|---|---|---|---|---|---|
| 31 | | + | ++ | 0 | 0 | 31, 32 |
| 32 | + | | + | 0 | − | 31, 32, 33 |
| 33 | ++ | + | | + | 0 | 32, 33 |
| 34 | 0 | 0 | + | | ++ | 34, 35 |
| 35 | 0 | − | 0 | ++ | | 34, 35 |

Based on the RSSI info, the nodes may be assigned to subgroups such that the link qualities between the nodes in a subgroup are preferably excellent but are at least good. In the “Result” column of Table 2, the nodes are indicated with an excellent link quality between them. However, to prevent subgroups of a single node, it may be necessary to include nodes in a subgroup which have a link with another node of the subgroup that is merely good. In Table 2, the quality of the links between nodes 31 and 32 and between nodes 32 and 33 is just good and not excellent. Using this approach, nodes may be assigned into two subgroups:
Subgroup 111: nodes 31, 32, 33
Subgroup 112: nodes 34, 35

FIG. 9 illustrates multiple ways of determining link quality. In the example of FIG. 9, a link quality between nodes 31 and 32 and a link quality between nodes 31 and 33 are determined. Transmissions between nodes 31 and 31 are performed multiple times with different transmission powers. The first transmissions 131 and 132 are performed with a higher transmission power than the second transmissions 134 and 135. As a result, the second transmission 135 is not received by the node 31. After the nodes have been grouped, the transmit power may be set to the nominal value.

If a link quality between one device and another device is determined based on a loss of packets transmitted by the one device to the other device, the resulting packet loss will result in a decreased link quality for the link between nodes 31 and 32. Link qualities may additionally or alternatively be determined based on roundtrip times of roundtrip message exchanges between pairs of devices.

In the example of FIG. 9, a round trip time 141 is measured between nodes 31 and 32 and a round trip time 142 of roundtrip message exchanges 137 and 138 is measured between nodes 31 and 33. Since the round trip time 141 is lower than the round trip time 142, the link quality of the link between nodes 31 and 32 may be determined to be higher than the link quality of the link between nodes 31 and 33, e.g. if round trip time is the only criterion. Similar ways may be used to determine the link quality between a sensing node and an access point. The round-trip time between a sensing node and an access point may be determined by having the sensing node ping the access point, for example. Not only the roundtrip time between sensing nodes or between sensing nodes and access points may be determined, but also between sensing nodes and a reference device in the local network or a reference device on the Internet.

A combination of metrics may be used to determine link qualities. For example, a controller may choose to use RSSI and also perform a quick calibration routine where each SSID (i.e. access point) is pinged X times and a message drop rate is determined. If the RSSI of two different links is different, but the links perform similarly in terms of message drop rate, the links might be considered to have a similar link quality. Other parameters that could be used is number of retries for different type of requests, average/min/max delays in returning pings, average/min/max RSSI values, average/min/max CSI (Channel State Information) values, Wi-Fi capabilities (e.g. single or dual band, with/without MIMO), for example.

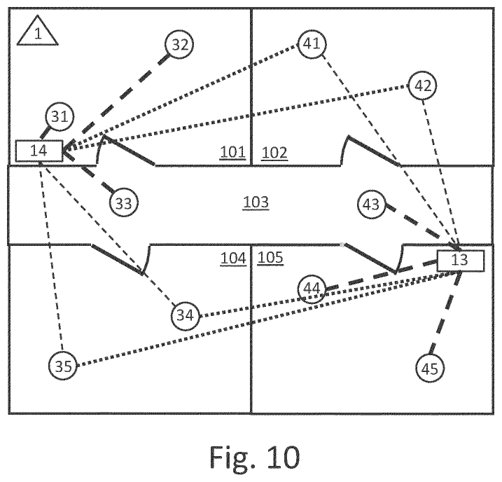

FIG. 10 shows the office floor of FIG. 5 with the RF sensing nodes of FIG. 1. In the example of FIG. 10, at least some of the sensing nodes 31-35, 41-45 use a different current access point in a first mode than in a second mode. A sensing node performs the radiofrequency-based sensing when it is in the first mode, but not when it is in the second mode.

The access points used by the sensing nodes in the first mode are selected with the method of FIG. 8. This method takes into account the link quality between a sensing node and the access points 13 and 14 and the suitability of frequency resources used by the access points 13 and 14. The access points used by the sensing nodes in the second mode are selected using a different method. For example, the sensing nodes may use a conventional method for selecting an access point based on RSSI in the second mode.

In the example of FIG. 10, the sensing nodes 31-33 connect to the access point 14 in both the first mode and the second mode and the sensing nodes 43-45 connect to the access point 13 in both the first mode and the second mode. The sensing nodes 34 and 35 connect to the access point 13 in the first mode and to the access point 14 in the second mode. The sensing nodes 41 and 42 connect to the access point 14 in the first mode and to the access point 13 in the second mode.

As a result, the sensing nodes 31-33 and 41-42 are assigned to the same RF sensing group, e.g. group A, and sensing nodes 34-35 and 43-45 are assigned to the same RF sensing group, e.g. group B. Nodes 31-33, 41-42 are assigned to a different sensing group than nodes 34-35, 43-45. A possible reason may be that the wall between hallway 103 and office 102 and the wall between hallway 103 and office 104 blocks a certain part of the spectrum that is useful for RF sensing.

The embodiments of FIGS. 4, 5, and 8 differ from each other in multiple aspects, i.e. multiple steps have been added or replaced. In variations on these embodiments, only a subset of these steps is added or replaced and/or one or more steps are omitted. For example, step 221 may be omitted from the embodiment of FIG. 5. The embodiments of FIGS. 5 and 7 may be combined.

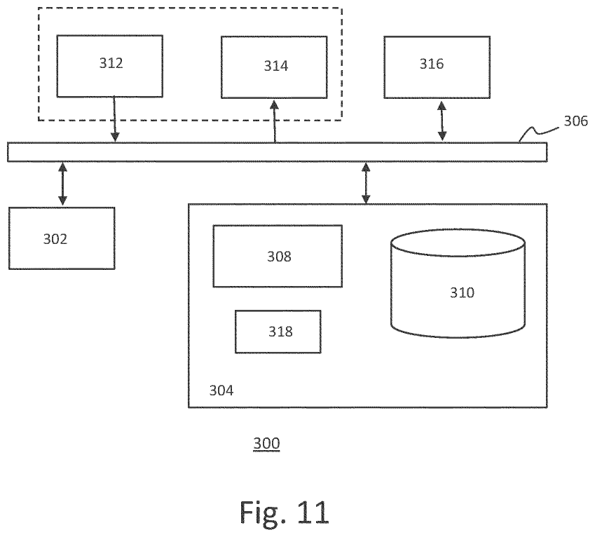

FIG. 11 depicts a block diagram illustrating an exemplary data processing system that may perform the method as described with reference to FIGS. 4, 5, and 8.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

The invention claimed is:

1. A system (1, 81) for configuring a radiofrequency-based sensing system, said radiofrequency-based sensing system being able to detect presence of humans, animals and/or objects based on changes in received radiofrequency signals, said radiofrequency-based sensing system comprising a plurality of radiofrequency-based sensing nodes (31-35, 41-45), each of said plurality of sensing nodes (31-35, 41-45) being associated with one of at least two access points (13-14, 63-64, 81, 94), said system (1, 81) comprising:
at least one input interface (3, 83);
at least one output interface (4, 84); and
at least one processor (5, 85) configured to:
obtain, via said at least one input interface (3, 83), connection information from said plurality of sensing nodes (31-35, 41-45) and/or from said at least two access points (13-14, 63-64, 81, 94),
determine, based on said connection information, one or more current access points by determining a current access point for each of said plurality of sensing nodes (31-35, 41-45), said at least two access points comprising said one or more current access points,
assign each of said plurality of sensing nodes (31-35, 41-45) to a group based on said current access point determined for said respective sensing node, and
configure, via said at least one output interface (4, 84), said radiofrequency-based sensing system to use said assignment to the respective group, such that each of said plurality of sensing nodes (31-35, 41-45) transmits and/or receives radiofrequency signals for said radiofrequency-based sensing, for detecting presence of humans, animals and/or objects, to and/or from one or more other sensing nodes (31-35, 41-45) in said respective sensing node's group only.

2. A system (1, 81) as claimed in claim 1, wherein said at least one processor (5, 85) is configured to:
assign a first sensing node, a second sensing node, a third sensing node, and a fourth sensing node of said plurality of sensing nodes (31-35, 41-45) to a first group,
assign said first sensing node and said second sensing node to a first subgroup (111) of said first group,
assign said third sensing node and said fourth sensing node to a second subgroup (112) of said first group, and
configure said radiofrequency-based sensing system to use said assignment of said first, second, third, and fourth sensing nodes to said first and second subgroups (111, 112) of said first group, each of said first, second, third, and fourth sensing nodes transmitting and/or receiving radiofrequency signals for said radiofrequency-based sensing to and/or from one or more other sensing nodes in said respective sensing node's subgroup.

3. A system (1, 81) as claimed in claim 2, wherein said at least one processor (5, 85) is configured to:
determine a link quality between said first, second and third sensing nodes,
assign said first sensing node and said second sensing node to said first subgroup based on said link qualities, and
assign said second sensing node and said third sensing node to said second subgroup based on said link qualities.

4. A system (1, 81) as claimed in claim 1, wherein said at least one processor (5, 85) is configured to:
determine a link quality between a sensing node of said plurality of sensing nodes and said at least two access points (13-14, 63-64, 81, 94),
determine a suitability of frequency resources used by said at least two access points (13-14, 63-64, 81, 94) for radiofrequency-based sensing,
select one of said at least two access points (13-14, 63-64, 81, 94) based on said link qualities and said suitability, and
cause said sensing node to use said selected access point as current access point.

5. A system (1, 81) as claimed in claim 4, wherein said at least one processor (5, 85) is configured to cause said sensing node to use said selected access point as current access point in a first mode, said sensing node using a further access point as current access point in said second mode, said sensing node being used to perform said radiofrequency-based sensing in said first mode, said sensing node not being used to perform said radiofrequency-based sensing in a second mode.

6. A system (1, 81) as claimed in claim 3 or 4, wherein said link qualities are determined based on received signal quality parameters and/or propagation delays of transmissions between pairs of devices and/or based on channel state information associated with said transmissions.

7. A system (1, 81) as claimed in claim 6, wherein said transmissions between said pairs of devices are performed multiple times.

8. A system (1, 81) as claimed in claim 7, wherein said transmissions between said pairs of devices are performed multiple times with different transmission powers.

9. A system (1, 81) as claimed in claim 3 or 4, wherein said link qualities are determined based on roundtrip times of roundtrip message exchanges between pairs of devices.

10. A system (1, 81) as claimed in claim 3 or 4, wherein, for each of said link qualities, a respective link quality between one device and another device is determined based on a loss of packets transmitted by said one device to said other device.

11. A system (1, 81) as claimed in claim 1, wherein said at least two access points (63-64) comprise a mesh router (63) and one or more mesh satellites (64).

12. A system (1, 81) as claimed in claim 1, wherein said at least one processor (5, 85) is configured to:
determine a link quality between a sensing node of said plurality of sensing nodes and said at least two access points (13-14, 63-64, 81, 94), a distance between said sensing node and a target sensing area being smaller than a threshold,
determine one or more distances between one or more of said at least two access points (13-14, 63-64, 81, 94) and said target sensing area, said one or more access points being able to transmit and/or receive radiofrequency signals for said radiofrequency-based sensing in said target sensing area,
select one of said at least two access points (13-14, 63-64, 81, 94) based on said link qualities and said one or more distances, and
cause said sensing node to use said selected access point as current access point.

13. A system (1, 81) as claimed in claim 1, wherein said at least one processor (5, 85) is configured to:
determine a link quality between a sensing node of said plurality of sensing nodes and said at least two access points (13-14, 63-64, 81, 94),
determine whether one or more wireless multipaths from said sensing node to said at least two access points (13-14, 63-64, 81, 94) pass through a target sensing area and have a signal strength exceeding a minimum signal strength,
select one of said at least two access points (13-14, 63-64, 81, 94) based on said link qualities and based on said determination whether one or more wireless multipaths pass through said target sensing area, and
cause said sensing node to use said selected access point as current access point.

14. A method of configuring a radiofrequency-based sensing system, said radiofrequency-based sensing system being able to detect presence of humans, animals and/or objects based on changes in received radiofrequency signals, said radiofrequency-based sensing system comprising a plurality of radiofrequency-based sensing nodes, each of said plurality of sensing nodes being associated with one of at least two access points, said method comprising:
obtaining (201) connection information from said plurality of sensing nodes and/or from said at least two access points;
determining (203), based on said connection information, one or more current access points by determining a current access point for each of said plurality of sensing nodes, said at least two access points comprising said one or more current access points;
assigning (205) each of said plurality of sensing nodes to a group based on said current access point determined for said respective sensing node; and
configuring (207) said radiofrequency-based sensing system to use said assignment to the respective group, such that each of said plurality of sensing nodes transmits and/or receives radiofrequency signals for said radiofrequency-based sensing, for detecting presence of humans, animals and/or objects, to and/or from one or more other sensing nodes in said respective sensing node's group only.

15. A computer program product for a computing device, the computer program product comprising computer program code to perform the method of claim 14 when the computer program product is run on a processing unit of the computing device.
